(19) United States
(12) Patent Application Publication
(10) Pub. No.: US 2024/0256361 A1
(43) Pub. Date: Aug. 1, 2024

(54) Predictive load modeling using a digital twin of a computing infrastructure

(71) Applicant: Bank of America Corporation, Charlotte, NC (US)

(72) Inventors: George Albero, Charlotte, NC (US); Maharaj Mukherjee, Poughkeepsie, NY (US); Jinna Zevulun Kim, Charlotte, NC (US); Timothy Scott Murphy, Charlotte, NC (US)

(21) Appl. No.: 18/162,772

(22) Filed: Feb. 1, 2023

(51) Int. Cl. G06F 9/50

(52) U.S. Cl. CPC G06F 9/5077; G06F 9/5083

(57) ABSTRACT

A system includes a computing infrastructure, a memory that stores a digital twin of the computing infrastructure, and at least one processor configured to generate simulated containers relating to a job flow, wherein each simulated container simulates a corresponding actual container relating to the job flow that is to run on the computing infrastructure. The digital twin is configured based on configuration parameters to mimic a particular state of the computing infrastructure. A simulation of the job flow is iteratively run on the configured digital twin to determine an allocation of the simulated containers to simulated hardware components that resulted in one or more performance parameters satisfying the respective thresholds.

### TECHNICAL FIELD

The present disclosure relates generally to data processing, and more specifically to predictive load modeling using a digital twin of a computing infrastructure.

### BACKGROUND

A computing infrastructure may include a plurality of hardware and software components. The hardware components may include computing nodes and the software components may include software applications that are run by one or more of the computing nodes to implement particular functionalities. The computing infrastructure may be configured to run several job flows implementing several respective functionalities in the computing infrastructure. A job flow generally includes a series of jobs that perform a particular task. When a job flow is loaded to a job scheduler for processing, a load balancing application generally divides the processing load between several computing nodes so that no single computing node is overloaded. However, present load balancing applications are not perfect solutions and thus often cause sub-optimal distribution of the processing load among processing resources leading to overloading of certain processing resources which may degrade overall performance of the computing infrastructure.

### SUMMARY

The system and methods implemented by the system as disclosed in the present disclosure provide technical solutions to the technical problems discussed above by assigning computing resources for processing a job flow in a manner that does not overload the computing resources. The disclosed system and methods provide several practical applications and technical advantages.

For example, the disclosed system and method provide the practical application of intelligently distributing a processing load relating to a job flow over computing resources of a computing infrastructure in a manner that does not overload the computing infrastructure or portions thereof and helps ensure that one or more performance parameters associated with the computing infrastructure are within specified threshold levels. As described in embodiments of the present disclosure, to determine an appropriate allocation of computing resources for processing a job flow, a load manager simulates processing of the job flow in a digital twin of the computing infrastructure and predicts an appropriate allocation of computing resources based on the simulation, wherein the digital twin is a software representation of the computing infrastructure. To simulate processing of the job flow, the load manager generates a plurality of simulated containers relating to the job flow, wherein each simulated container simulates a corresponding actual container relating to the job flow that is to run on the computing infrastructure when actually processing the job flow in the computing infrastructure. The load manager receives configuration parameters relating to the digital twin, wherein the configuration parameters, when applied to the digital twin, configure the digital twin to mimic a particular state of the computing infrastructure. The load manager configures the digital twin based on the received configuration parameters and runs a simulation of the job flow on the configured digital twin. The simulation comprises deploying using a simulated load balancer of the digital twin, the simulated containers relating to the job flow on a plurality of simulated hardware components in a portion of the digital twin representing a corresponding portion of the computing infrastructure. The load manager records one or more performance parameters as a result of the simulation and checks whether one or more of the performance parameters satisfy respective performance thresholds. In response to detecting that one or more performance parameters do not satisfy respective performance thresholds, load manager runs an iterative process including iteratively reallocating at least a portion of the simulated containers to simulated hardware resources on a different portion of the digital twin and checking the performance parameters after each reallocation. In other words, at each iteration some of the simulated containers being processed by overloaded simulated computing nodes are reallocated to other simulated computing nodes to ease the central processing unit (CPU) load on the overloaded simulated computing nodes. The load manager ends the iterations when a re-allocation of the simulated containers results in the one or more performance parameters satisfying the respective performance thresholds. The load manager records the allocation of the simulated containers that resulted in the one or more performance parameters satisfying the respective thresholds and then assigns actual containers relating to the job flow to hardware components in the computing infrastructure according to the recorded allocation of the simulated containers.

By determining an allocation of containers associated with a job flow in a manner that satisfies performance thresholds relating to performance parameters associated with the computing infrastructure, the disclosed system and method helps ensure that the computing resources of the computing infrastructure are not overloaded and that the job flow is successfully processed. Avoiding overloading of CPUs in the computing infrastructure improves CPU performance and general processing performance of computing nodes in the computing infrastructure. Further, avoiding overloading of computing nodes in turn avoids server outages which also contributes to improved processing performance of the computing infrastructure. Thus, the disclosed system and method generally improve the technology related to load balancing in computing systems.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates a flowchart of an example method for simulating a job flow, in accordance with one or more embodiments of the present disclosure; and

FIG. 3 illustrates an example schematic diagram of a load manager shown in FIG. 1, in accordance with one or more aspects of the present disclosure.

### DETAILED DESCRIPTION

Embodiments of the present disclosure are generally directed to assigning computing resources to process a job flow in a computing infrastructure by predictive load modeling using a digital twin of the computing infrastructure to help ensure that the computing resources assigned for processing the job flow and any other dependent systems operate within thresholds specified for performance parameters. The techniques disclosed herein may be used for several applications. In one embodiment, the disclosed techniques may be used for predictive load balancing including assigning computing resources across at least a portion of the computing infrastructure such that no portion of the assigned computing resources equals or exceeds a pre-configured computing load threshold. In a second embodiment, the disclosed techniques may be used for capacity planning including determining a minimum amount of computing resources needed to process a job flow. In a third embodiment, the disclosed techniques may be used to plan for planned and unplanned resource outages including an amount of computing redundancy needed to support a job flow during a resource outage.

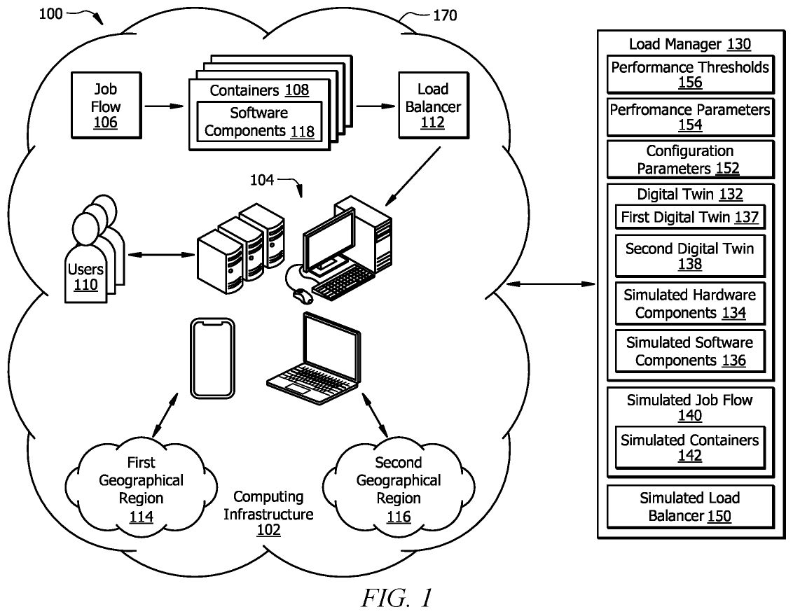

FIG. 1 is a schematic diagram of a system 100, in accordance with certain aspects of the present disclosure. As shown, system 100 includes a computing infrastructure 102 including a plurality of computing nodes 104 connected to a network 170. Computing infrastructure 102 may include a plurality of hardware and software components. The hardware components may include, but are not limited to, computing nodes 104 such as desktop computers, smartphones, tablet computers, laptop computers, servers and data centers, and other hardware devices such as printers, routers, hubs, switches, and memory devices all connected to the network 170. Software components may include software applications that are run by one or more of the computing nodes 104 including, but not limited to, operating systems, user interface applications, third party software, database management software, service management software, data center software, metaverse software and other customized software programs implementing particular functionalities. For example, software code relating to one or more software applications may be stored in a memory device and one or more processors may process the software code to implement respective functionalities. In one embodiment, at least a portion of the computing infrastructure 102 may be representative of an Information Technology (IT) infrastructure of an organization.

One or more of the computing nodes 104 may be operated by a user 110. For example, a computing node 104 may provide a user interface which a user 110 may operate the computing node 104 to perform data interactions within the computing infrastructure 102.

Each computing node 104 of the computing infrastructure 102 may be representative of a computing system hosting software applications that may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 170, in general, may be a wide area network (WAN), a personal area network (PAN), a cellular network, or any other technology that allows devices to communicate electronically with other devices. In one or more embodiments, network 170 may be the Internet.

One or more computing nodes 104 may implement one or more other services or functionalities such as load manager 130 described below in detail. For example, one or more computing nodes 104 may run respective software programs to implement the load manager 130.

The computing infrastructure 102 may be configured to run several job flows 106 implementing several respective functionalities in the computing infrastructure 102. For example, a portion of the computing infrastructure 102 (e.g., a portion of the computing nodes 104 and associated software components) may implement a data center that includes a plurality of servers, data storage drives and network equipment. In this example, the data center may be configured to run job flows to implement several operations associated with an organization that owns and/or manages the computing infrastructure 102. A job flow 106 generally includes a series of jobs that perform a particular task. The jobs in a job flow 106 may or may not depend on each other. For example, a downstream job may need processing results from an upstream job, wherein the downstream job may not process without the upstream job completing its processing. The term “job” typically refers to a unit of work or a unit of execution that performs the work.

The computing infrastructure 102 may process a job flow 106 as a plurality of containers 108. The term “container” generally refers to a self-contained virtual environment that includes software components 118 to process at least a portion of a job relating to a job flow 106. A single container 108 may be used to run anything from a small microservice or software process to a larger application. A container 108 generally includes all the necessary executables, binary code, libraries, and configuration files needed to process the job or a portion thereof. Generally, when a job flow 106 is loaded to a job scheduler for processing, the series of jobs in the job flow 106 are divided into a plurality of containers 108 and a load balancer 112 distributes the plurality of containers 108 across several computing nodes 104 so that the processing load associated with processing the job flow 106 is shared between the several computing nodes 104 in a manner that maximizes speed and capacity utilization and ensure that no single computing node 104 is overloaded, which could degrade performance and lead to outages.

However, present load balancing applications are sub-optimal solutions and thus often cause sub-optimal distribution of processing resources (e.g., computing nodes 104) leading to overloading of certain processing resources which may degrade overall performance of the computing infrastructure 102.

Embodiments of the present disclosure relate to distributing containers 108 relating to a job flow 106 over processing resources (e.g., computing nodes 104) of the computing infrastructure 102 in a manner that does not overload the computing resources and helps ensure that one or more performance parameters 154 associated with the computing infrastructure 102 are within specified threshold levels.

As described in further detail below, to determine an appropriate routing of the containers 108 related to a job flow 106 to computing nodes 104 of the computing infrastructure 102, the disclosed embodiments describe simulating the job flow 106 in a digital twin 132 of the computing infrastructure 102 and predicting the most appropriate distribution of the containers 108 to the computing nodes 104 for actually processing the job flow 106 in the computing infrastructure 102.

The digital twin 132 is a software representation of the computing infrastructure 102 or a portion thereof. In other words, the digital twin 132 is a virtual representation of the physical computing infrastructure 102, wherein the hardware components, and software components of the computing infrastructure 102 as well as interrelations and inter-dependencies between the components are programmatically simulated in the digital twin 132. For example, a hardware component (e.g., computing node 104) of the computing infrastructure 102 is represented in the digital twin 132 as a simulated hardware component 134. Similarly, a software component of the computing infrastructure 102 is represented in the digital twin 132 as a simulated software component 136. The digital twin 132 may run on one or more servers or other suitable computing nodes 104 in the computing infrastructure 102.

In certain embodiments, the digital twin 132 may represent a portion of the computing infrastructure 102. For example, the digital twin 132 may represent a particular set of hardware components, a particular set of software components or a combination thereof of the computing infrastructure 102. In one embodiment, the digital twin 132 may represent a data center included in the computing infrastructure 102. In additional or alternative embodiments, the digital twin 132 may represent a network of two or more digital twins 132, wherein each digital twin 132 of the network of digital twins 132 represents a different portion of the computing infrastructure 102. For example, when the computing infrastructure 102 of a global organization is deployed in several countries across the globe, a super digital twin 132 may be used to represent the entire computing infrastructure 102. The super digital twin 132 may include a network of digital twins 132, wherein each digital twin 132 of the network may represent a portion of the computing infrastructure 102 deployed in a different geographical region. In one embodiment, the different portions of the computing infrastructure 102 represented by the corresponding digital twins 132 may overlap. For example, a first digital twin 132 and a second digital twin 132 may share one or more hardware and/or software components. For example, the first digital twin 132 may represent a first portion of the computing infrastructure 102 deployed in a particular city while the second digital twin 132 may represent a second portion of the computing infrastructure deployed in a larger area (e.g., a state in which the city is located) including the first portion deployed in the particular city. In certain embodiments, different digital twins 132 may represent respective non-overlapping portions of the computing infrastructure.

In some embodiments, the digital twin 132 provides real-time or near real-time simulation of the computing infrastructure 102 or portions thereof such that the digital twin 132 is a real-time or near real-time replica of the computing infrastructure at any time. Load manager 130 may be configured to receive real-time data relating to the computing infrastructure 102 and update the digital twin 132 based on the real-time data to mimic a real-time state of the computing infrastructure 102 or a portion thereof represented by the digital twin 132. The real-time data received from the computing infrastructure 102 may be operational data relating to the operation of computing nodes 104. For example, the real-time data may include, but is not limited to, one or more of CPU-temperature, airflow information, workload processing, memory usage, processor usage, network traffic, or other information describing or affecting the operation of the computing nodes 104. The real-time data relating to the computing nodes 104 or other hardware and software components of the computing infrastructure 102 may be collected using sensors deployed across the computing infrastructure 102. These sensors may be physical sensors integrated as part of, connected to, or located proximate to the hardware and software components represented by digital twin 132.

In other embodiments, load manager 130 may be configured to configure the digital twin 132 based on one or more configuration parameters 152 to mimic or replicate a particular state of the computing infrastructure 102 or a portion thereof represented by the digital twin 132. This particular state may be different from or may include the real-time or near real-time state of the computing infrastructure 102. For example, the digital twin 132 may be configured based on one or more configuration parameters 152 to mimic an expected state of the computing infrastructure 102 or a portion thereof on a particular day of the year, for example a popular holiday of the year, when the computing loads are higher than normal. The configuration parameters 152 based on which the digital twin 132 may be configured may include, but are not limited to, one or more of a particular time of a particular day, a particular day of a particular week, a particular day of a particular month, a particular geographical region related to the computing infrastructure 102, one or more particular servers of the computing infrastructure, one or more particular software components of the computing infrastructure, a particular central processing unit (CPU) load, a particular CPU-temperature, a particular amount of memory allocation, and an outage of one or more computing nodes 104 (e.g., computing servers).

In one embodiment, the load manager 130 may configure the digital twin 132 to mimic a previous state of the computing infrastructure 102 or a portion thereof. A state of the computing infrastructure 102 at any particular time may be represented by a combination of values associated with one or more of the configuration parameters 152. Computing nodes 104 of the computing infrastructure 102 may be configured to record the values associated with the configuration parameters 152 at any given time and transmit a combination of recorded values relating to the configuration parameters 152 to the load manager 130. The particular combination of recorded values represents a snapshot of the computing infrastructure 102 at the time the values where recorded. This combination of recorded values relating to the configuration parameters 152 may be stored by the load manager 130 as a historical state of the computing infrastructure 102 or portions thereof. The load manager 130 may be configured to subsequently configure the digital twin 132 based on the recorded values of the configuration parameters 152 to replicate the same previous state of the computing infrastructure 102. In one embodiment, the configuration parameters 152 may include real-time or near-real time data received from the computing infrastructure 102. For example, the computing infrastructure may transmit to the load manager 130 in real-time or near real-time, values of one of more configuration parameters 152. Load manager 130 may be configured to configure the digital twin 132 based on the real-time values of the configuration parameters received from the computing infrastructure 102 to generate a real-time or near-real time state of the computing infrastructure 102.

In certain embodiments, custom values may be assigned to one or more configuration parameters 152. Load manager 130 may be configured to configure the digital twin 132 based on the custom values of the one or more configuration parameters 152 to simulate a hypothetical state of the computing infrastructure. For example, the digital twin 132 may be configured to simulate a hypothetical state when one or more pre-selected servers of the computing infrastructure 102 are out of operation. Load manager 130 may be configured to run a simulation of a job flow 106 (shown as simulated job flow 140) on the digital twin 132 to mimic an actual processing of the job flow 106 in the computing infrastructure 102 or a portion thereof represented by the digital twin 132. In one embodiment, the load manager 130 may run the job flow 106 on the digital twin 132 that is configured to represent a real-time or near-real time state of the computing infrastructure 102. In an alternative or additionally embodiment, the load manager 130 may run the job flow 106 on the digital twin 132 configured to represent a previous state, an expected future state or a hypothetical state of the computing infrastructure 102. To run the simulated job flow 140, load manager 130 may be configured to simulate the containers 108 (shown as simulated containers 142) that need to be processed in the computing infrastructure 102 to process the job flow 106. As further described below, the load manager 130 may be configured to run an iterative process to predict a most suitable allocation of computing resources (e.g., computing nodes 104) for the containers 108 when processing the job flow 106.

The load manager 130 may be configured to measure performance parameters 154 during a simulation of a given job flow 106. Each performance parameter 154 is indicative of a performance of a simulated hardware component 134 of the computing infrastructure and/or a simulated software component of the computing infrastructure. In one embodiment, while running a simulation of the job flow 106, load manager 130 may be configured to record values of one or more performance parameters 154 indicating performance of one or more simulated hardware components (e.g., computing nodes 104) of the computing infrastructure 102. For example, load manager 130 may be configured to record values of performance parameters 154 associated with simulated computing nodes assigned to process the simulated containers 142. Additionally or alternatively, load manager 130 may be configured to record values of performance parameters 154 associated with one or more simulated computing nodes that depend on and/or are affected by the simulated computing nodes assigned to process the simulated containers 142. As described below, load manager 130 may iteratively run the simulated job flow 140 until one or more of the recorded performance parameters 154 satisfy respective pre-configured performance thresholds 156. The performance parameters 154 may include, but are not limited to, one or more of whether the simulated job flow 140 was successfully processed in the digital twin 132, a job latency of one or more simulated jobs in the simulated job flow 140, a CPU-temperature of one or more simulated CPUs in the computing infrastructure 102, a CPU load at one or more simulated computing nodes of the computing infrastructure 102, and a memory allocation at one or more simulated computing nodes (e.g., servers) of the computing infrastructure 102.

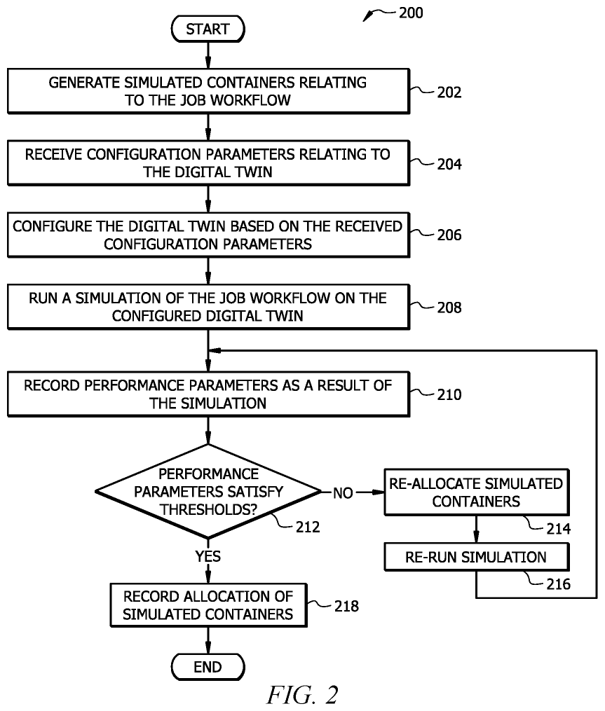

Operation of the load manager 130 will not be described with reference to FIG. 2.

FIG. 2 illustrates a flowchart of an example method 200 for simulating a job flow 106, in accordance with one or more embodiments of the present disclosure. Method 200 may be performed by load manager 130 shown in FIG. 1.

At operation 202, load manager 130 generates a plurality of simulated containers 142 relating to a job flow 106 that is to run on the computing infrastructure 102, wherein each simulated container 142 simulates a corresponding actual container 108 relating to the job flow 106, and wherein each container 108 is a self-contained virtual environment that comprises software components 118 to process at least a portion of a job relating to the job flow.

As described above, when a job flow 106 is loaded to a job scheduler for processing, the series of jobs in the job flow 106 are divided into a plurality of containers 108 and a load balancer 112 distributes the plurality of containers 108 for processing across several computing nodes 104. Load manager 130 may be configured to simulate processing of the job flow 106 in a digital twin 132 of the computing infrastructure or a portion thereof configured to represent a selected state, to predict distribution of the containers 108 relating to the job flow 106 over processing resources (e.g., computing nodes 104) of the computing infrastructure 102 in a manner that does not overload the computing resources of the computing infrastructure 102 and helps ensure that one or more performance parameters associated with the computing infrastructure are within specified threshold levels, when actually processing the job flow 106 in the computing infrastructure 102.

As described above, the digital twin 132 is a software representation of the computing infrastructure 102 or a portion thereof. In other words, the digital twin 132 is a virtual representation of the physical computing infrastructure 102, wherein the hardware components, and software components of the computing infrastructure 102 as well as interrelations and inter-dependencies between the components are programmatically simulated in the digital twin 132. For example, a hardware component (e.g., computing node 104 such as a processing server) of the computing infrastructure 102 is represented in the digital twin 132 as a simulated hardware component 134 (e.g., simulated processing server). Similarly, a software component of the computing infrastructure 102 is represented in the digital twin 132 as a simulated software component 136.

Load manager 130 may be configured to run a simulation of a job flow 106 (shown as simulated job flow 140) on the digital twin 132 to mimic an actual processing of the job flow 106 in the computing infrastructure 102 or a portion thereof represented by the digital twin 132. To run the simulated job flow 140, load manager 130 may be configured to simulate the containers 108 (shown as simulated containers 142) that need to be processed in the computing infrastructure 102 to process the job flow 106.

At operation 204, load manager 130 receives configuration parameters 152 relating to the digital twin 132, wherein the configuration parameters 152, when applied to the digital twin 132, configure the digital twin to mimic a particular state of the computing infrastructure 102.

At operation 206, load manager 130 configures the digital twin 132 based on the received configuration parameters 152.

As described above, load manager 130 may configure the digital twin 132 based on one or more configuration parameters 152 to mimic or replicate a particular state of the computing infrastructure 102 or a portion thereof. This particular state may be the real-time or near real-time state of the computing infrastructure 102, a previously recorded state of the computing infrastructure 102, a future expected state of the computing infrastructure 102 or a hypothetical state of the computing infrastructure 102. The configuration parameters 152 allow the load manager to run a simulated job flow 140 in several real-time, expected, historical and hypothetical scenarios, thus allowing the load manager 130 to determine a best allocation of the containers 108 in each of the scenarios and/or across multiple scenarios. The configuration parameters 152 based on which the digital twin 132 may be configured may include, but are not limited to, one or more of a particular time of a particular day, a particular day of a particular week, a particular day of a particular month, a particular geographical region related to the computing infrastructure 102, one or more particular servers of the computing infrastructure, one or more particular software components of the computing infrastructure, a particular central processing unit (CPU) load, a particular CPU-temperature, a particular amount of memory allocation, and an outage of one or more servers.

The load manager 130 may configure the digital twin 132 to mimic a previous state of the computing infrastructure 102 or a portion thereof. A state of the computing infrastructure 102 at any particular time may be represented by a combination of values associated with one or more of the configuration parameters 152. Computing nodes 104 of the computing infrastructure 102 may be configured to record the values associated with the configuration parameters 152 at any given time and transmit a combination of recorded values relating to the configuration parameters to the load manager 130. The particular combination of recorded values represents a snapshot of the computing infrastructure 102 at the time the values where recorded. This combination of recorded values relating to the configuration parameters 152 may be stored as a historical state of the computing infrastructure 102 or portions thereof. The load manager 130 may be configured to subsequently configure the digital twin 132 based on the recorded values of the configuration parameters 152 to replicate the same previous state of the computing infrastructure 102.

The load manager 130 may configure the digital twin 132 based on one or more configuration parameters 152 to mimic an expected state of the computing infrastructure 102 or a portion thereof on a particular day of the year, for example a popular holiday of the year, when the computing loads are higher than normal. In this case, the values of one or more configuration parameters 152 used to configure the digital twin 132 may be expected values based on historical records. For example, when simulating a particular day of the year, the expected CPU load on the particular day of the year may be set to an average CPU load recorded on the same day of previous few years. Adjustments may be made to the average CPU load based on specific information relating to expected CPU loads relating to the particular day.

The load manager 130 may configure the digital twin 132 to replicate a real-time or near real-time state of the computing infrastructure 102 or a portion thereof. In this case, the values of the configuration parameters 152 may include real-time or near-real time data received from the computing infrastructure 102. For example, the computing infrastructure 102 may transmit to the load manager 130 real-time or near real-time values of one of more configuration parameters 152. Load manager 130 may be configured to configure the digital twin 132 based on the real-time values of the configuration parameters 152 received from the computing infrastructure 102 to generate a real-time or near-real time state of the computing infrastructure.

In certain embodiments, custom values may be assigned to one or more configuration parameters 152. Load manager 130 may be configured to configure the digital twin 132 based on the custom values of the one or more configuration parameters 152 to simulate a hypothetical state of the computing infrastructure 102. For example, the digital twin 132 may be configured to simulate a hypothetical state when one or more pre-selected servers of the computing infrastructure 102 are out of operation, to simulate different load conditions (e.g., CPU load, memory allocation etc.) and the like.

At operation 208, load manager 130 runs a simulation of the job flow (e.g., simulated job flow 140) on the digital twin 132 that is configured based on the configuration parameters 152, wherein the simulation comprises deploying using a simulated load balancer 150 of the digital twin 132, the simulated containers 142 relating to the job flow 106 on a plurality of simulated hardware components 134 in a portion of the digital twin 132 representing a corresponding portion of the computing infrastructure 102. As described above, load manager 130 may be configured to run a simulation of the job flow 106 (shown as simulated job flow 140) on the digital twin 132 to mimic an actual processing of the job flow 106 in the computing infrastructure 102 or a portion thereof represented by the digital twin 132. As a first step of running the simulated job flow 140, load manager 130 uses the simulated load balancer 150 to allocate the simulated containers 142 to simulated hardware components 134 (e.g., simulated processing resources) of the computing infrastructure 102. The simulated load balancer 150 simulates an actual load balancer 112 of the computing infrastructure 102 that is configured to distribute the plurality of containers 108 of the job flow 106 for processing across several computing nodes 104 so that the processing load associated with processing the job flow 106 is shared between the several computing nodes 104. However, present load balancing applications are not perfect solutions and thus often cause sub-optimal distribution of processing resources (e.g., computing nodes 104) leading to overloading of certain processing resources which may degrade overall performance of the computing infrastructure. Thus, the simulated load balancer 150 which mimics the actual load balancer 112 of the computing infrastructure 102 may not predict an appropriate allocation of the simulated containers 142 in a manner that keeps performance parameters 154 associated with the computing infrastructure 102 within specified threshold levels.

At operation 210, load manager 130 records at least one performance parameter 154 as a result of the simulation, wherein the at least one performance parameter 154 is indicative of a performance of a simulated hardware component 134 of the computing infrastructure 102. As described above, the load manager 130 may be configured to measure performance parameters 154 during a simulation of a given job flow 106. Each performance parameter 154 is indicative of a performance of a simulated hardware component of the computing infrastructure and/or a simulated software component of the computing infrastructure. In one embodiment, while running a simulation of the job flow 106, load manager 130 may be configured to record values of one or more performance parameters 154 indicating performance of one or more simulated hardware components (e.g., computing nodes 104) of the computing infrastructure 102. For example, load manager 130 may be configured to record values of performance parameters 154 associated with simulated computing nodes assigned to process the simulated containers 142. Additionally, or alternatively, load manager 130 may be configured to record values of performance parameters 154 associated with one or more simulated computing nodes that depend on and/or affected by the simulated computing nodes assigned to process the simulated containers 142. The performance parameters 154 may include, but are not limited to, one or more of whether the simulated job flow 140 was successfully processed in the digital twin 132, a job latency of one or more simulated jobs in the simulated job flow 140, a CPU-temperature of one or more simulated CPUs in the computing infrastructure 102, a CPU load at one or more simulated computing nodes of the computing infrastructure 102, and a memory allocation at one or more simulated computing nodes (e.g., servers) of the computing infrastructure 102.

At operation 212, load manager 130 checks whether the recorded values of one or more of the performance parameters 154 satisfy respective pre-configured performance thresholds 156. For example, for each recorded value of CPU load, load manager 130 may check whether the recorded CPU load is below a pre-configured threshold CPU load. In this example, each recorded value of the CPU load may correspond to a particular simulated computing node 104 of the computing infrastructure 102.

If most recorded values (e.g., at least a pre-selected percentage of values) or all recorded values of one or more performance parameters 154 satisfy respective thresholds, method 200 proceeds to operation 218 where load manager 130 records an allocation of the simulated containers 142 that resulted in the one or more performance parameters satisfying the respective performance thresholds 156.

If one or more performance parameters 154 are found to not satisfy respective performance thresholds 156, method 200 proceeds to operations 214 and 216 where load manager 130 runs an iterative process to determine a best allocation for the simulated containers 142. For example, when a minimum number of recorded CPU load values (e.g., at least a pre-selected percentage of values) equal or exceed respective threshold CPU load, load manager 130 iteratively runs the simulated job flow 140 until the one or more recorded performance parameters satisfy respective pre-configured performance thresholds 156.

At operation 214, load manager 130 reallocates at least a portion of the simulated containers 142 to a plurality of simulated hardware components 134 of a different portion of the digital twin 132 representing a corresponding different portion of the computing infrastructure 102. For example, when the CPU load relating to one or more simulated computing nodes equals or exceeds a threshold CPU load, load manager 130 reallocates one or more simulated containers 142 previously allocated to the one or more overloaded simulated computing nodes to other simulated computing nodes in a different portion of the digital twin 132. In other words, some of the simulated containers 142 being processed by overloaded simulated computing nodes are reallocated to other simulated computing nodes to ease the CPU load on the overloaded simulated computing nodes.

In certain embodiments, as described above, the digital twin 132 may include two or more digital twins 132, wherein each digital twin 132 may represent a different portion of the computing infrastructure 102. For example, digital twin 132 may include a first digital twin 132 that represents a first portion of the computing infrastructure 102 in a first geographical region 114 and a second digital twin 132 that represents a second portion of the computing infrastructure 102 in a second geographical region 116. When running the simulated job flow 140 according to method 200, load manager 130 may first allocate (e.g., using the simulated load balancer 150 at operation 208) the simulated containers 142 to a first set of simulated hardware components 134 in the first digital twin 132. However, if one or more performance parameters 154 do not satisfy respective performance thresholds 156, load manager 130 may allocate one or more simulated containers 142 to a second set of simulated hardware components 134 in the second digital twin 132.

At operation 216, after re-allocating one or more simulated containers 142 to a different portion of the digital twin 132, load manager 130 reruns the simulated job flow 140 with the modified allocation of the simulated containers 142.

After rerunning the simulated job flow 140 at operation 216, method 200 moves back to operation 210 where performance parameters 154 from the rerun simulation are recorded and then the recorded performance parameters 154 are again checked at operation 212. If the one or more performance parameters 154 still do not satisfy respective performance thresholds 156, load manager 130 runs another iteration by re-allocating more simulated containers 142 at operation 214 by rerunning the simulated job flow 140 with modified allocation of simulated containers 142.

After running any one iteration, if the load manager 130 detects (e.g., at operation 212) that the one or more performance parameters 154 satisfy the respective performance thresholds 156, load manager 130 records an allocation of the simulated containers 142 that resulted in the one or more performance parameters satisfying the respective performance thresholds 156.

In one embodiment, the load manager 130 may be configured with the one or more performance parameters 154 which need to satisfy respective performance thresholds 156 for the iterations to end and for the load manager 130 to record the allocation at operation 218. In one embodiment, the load manager 130 may be configured to end the iterations after a pre-configured maximum number of iterations have been performed and record the allocation of simulated containers 142 from the last iteration.

Once method 200 ends and the allocation of simulated containers 142 has been recorded, load manager 130 may be configured to run the actual job flow 106 by assigning the actual containers 108 relating to the job flow 106 to hardware components (e.g., computing nodes 104) in the computing infrastructure 102 according to the recorded allocation of the simulated containers 142 that resulted in the one or more performance parameters 154 satisfying the respective performance thresholds 156. By allocating computing resources to containers 108 relating to the job flow 106 in accordance with the allocation of simulated containers 142 determined when running the simulated job flow 140 that satisfy respective performance thresholds 156 associated with one or more performance parameters 154, method 200 helps ensure that the job flow 106 is processed successfully in the computing infrastructure 102 without overloading computing nodes 104.

In certain embodiments, method 200 may be used to determine allocation of containers 108 relating to the job flow 106 to a best set of computing nodes 104 across multiple states and corresponding load conditions of the computing infrastructure. For example, several sets of values for the configuration parameters 152 may be defined, wherein each set of values represents a different state of the computing infrastructure 102. The load manager 130 may configure the digital twin 132 based on each set of values to replicate a corresponding state of the computing infrastructure 102. These different states of the computing infrastructure 102 may include, but are not limited to, one or more of a state of the computing infrastructure 102 on a particular day, a state of the computing infrastructure 102 at a particular time, a state of the computing infrastructure 102 when one or more computing servers are out of service, and a state of the computing infrastructure 102 that corresponds to a portion of the computing infrastructure 102 in a particular geographical region. The load manager 130 may perform method 200 on the digital twin 132 corresponding to the multiple states of the computing infrastructure 102 to determine a best allocation of the containers 108 across all defined states of the computing infrastructure 102. This allows the load manager 130 to simulate several what-if scenarios and determine a best allocation of the containers 108 across all scenarios.

In some embodiments, method 200 may be used for capacity planning. For example, simulating the job flow 106 according to method 200 for a particular state (e.g., expected state) of the computing infrastructure and determining a predicted allocation of computing resources for the containers 108 that satisfy performance thresholds 156 allows the load manager 130 to determine an amount of computing resources (e.g., computing nodes 104) needed to process the job flow 106. This helps with capacity planning by pre-allocating needed computing resources for processing the job flow 106. This may be particularly helpful when cloud resources are used to run the job flow 106. So, when the load manager 130 predicts that a higher amount of computing resources are required to run the job flow 106 on a particular day, additional cloud computing resources may be requested beforehand so that sufficient computing resources are available on the particular day to process the job flow 106 without overlading they systems.

Method 200 may also be used to plan for planned and unplanned outages. For example, one or more computing servers of the computing infrastructure 102 may be scheduled to taken out of service for maintenance. This scenario may be replicated by configuring the digital twin 132 based on appropriate configuration parameters 152. Running the simulated job flow 140 in this scenario according to method 200 may yield a appropriate allocation for the containers 108 that can be used during the planned outage. Similarly container allocations may also be determined for unplanned outages by configuring the digital twin 132 to represented any hypothetical outages and then running the simulated job flow 140 to determine the best allocation of the containers 108 that may work during the unplanned outage.

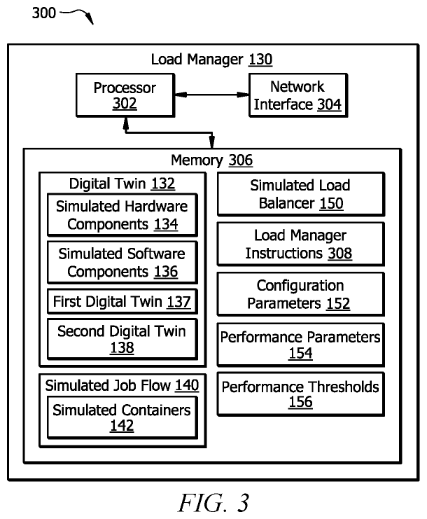

FIG. 3 illustrates an example schematic diagram 300 of a load manager 130 shown in FIG. 1, in accordance with one or more aspects of the present disclosure.

The load manager 130 comprises a processor 302, a memory 306, and a network interface 304. The load manager 130 may be configured as shown in FIG. 3 or in any other suitable configuration.

The processor 302 comprises one or more processors operably coupled to the memory 306. The processor 302 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors 302 are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors 302 are configured to implement various instructions. For example, the one or more processors 302 are configured to execute instructions (e.g., load manager instructions 308) to implement the load manager 130. In this way, processor 302 may be a special-purpose computer designed to implement the functions disclosed herein. In one or more embodiments, the load manager 130 is implemented using logic units, FPGAs, ASICs, DSPs, or any other suitable hardware. The load manager 130 is configured to operate as described with reference to FIG. 2. For example, the processor 302 may be configured to perform at least a portion of the method 200 as described in FIG. 2.

The memory 306 comprises one or more disks, tape drives, or solid-state drives, and may be used as an over-flow data storage device, to store programs when such programs are selected for execution, and to store instructions and data that are read during program execution. The memory 306 may be volatile or non-volatile and may comprise a read-only memory (ROM), random-access memory (RAM), ternary content-addressable memory (TCAM), dynamic random-access memory (DRAM), and static random-access memory (SRAM).

The memory 306 is operable to store the digital twin 132 (including first digital twin 137, second digital twin 138, simulated hardware components 134 and simulated software components 136), the simulated job flow 140 (including the simulated containers 142), the simulated load balancer 150, the configuration parameters 152, the performance parameters 154, the performance thresholds 156 and the load manager instructions 308. The load manager instructions 308 may include any suitable set of instructions, logic, rules, or code operable to execute the load manager 130.

The network interface 304 is configured to enable wired and/or wireless communications. The network interface 304 is configured to communicate data between the load manager 130 and other devices, systems, or domains (e.g. computing nodes 104 of the computing infrastructure 102). For example, the network interface 304 may comprise a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a computing infrastructure comprising a plurality of computing nodes;
a memory that stores a digital twin of at least a portion of the computing infrastructure, wherein the digital twin is a software representation of at least the portion of the computing infrastructure; and
at least one processor communicatively coupled to the computing infrastructure and the memory, wherein the at least one processor is configured to:
generate a plurality of simulated containers relating to a job flow, wherein each simulated container simulates a corresponding actual container relating to the job flow that is to run on the computing infrastructure, and wherein each container is a self-contained virtual environment that comprises software components to process at least a portion of a job relating to the job flow;
receive configuration parameters relating to the digital twin, wherein the configuration parameters, when applied to the digital twin, configure the digital twin to mimic a particular state of the computing infrastructure;
configure the digital twin based on the received configuration parameters;
run a simulation of the job flow on the digital twin that is configured based on the configuration parameters, wherein the simulation comprises deploying using a simulated load balancer of the digital twin, the simulated containers relating to the job flow on a plurality of simulated hardware components in a portion of the digital twin representing a corresponding portion of the computing infrastructure;
record at least one performance parameter as a result of the simulation, wherein the at least one performance parameter is indicative of a performance of a simulated hardware component of the computing infrastructure; and
if one or more of the performance parameters do not satisfy respective thresholds, run an iteration comprising:
reallocating at least a portion of the simulated containers to a plurality of simulated hardware components of a different portion of the digital twin representing a corresponding different portion of the computing infrastructure;
rerunning the simulation after reallocating at least the portion of the simulated containers; and
if the one or more performance parameters satisfy the respective thresholds, recording an allocation of the simulated containers that resulted in the one or more performance parameters satisfying the respective thresholds.

2. The system of claim 1, wherein the at least one processor is further configured to assign actual containers relating to the job flow to the computing nodes in the computing infrastructure according to the recorded allocation of the simulated containers that resulted in the one or more performance parameters satisfying the respective thresholds, wherein the actual containers correspond to the simulated containers.

3. The system of claim 1, wherein the processor is further configured to after rerunning the simulation, if the one or more performance parameters do not satisfy the respective thresholds, rerun the iteration.

4. The system of claim 1, wherein each simulated hardware component comprises a simulation of a computing node in the computing infrastructure.

5. The system of claim 1, wherein:
the digital twin comprises a first digital twin and a second digital twin;
the first digital twin is a software representation of a first portion of the computing infrastructure;
the second digital twin is a software representation of a second portion of the computing infrastructure; and
the at least one processor is configured to:
run the simulation of the job flow on the digital twin by deploying the simulated containers on a first set of simulated hardware components of the first digital twin; and
if the one or more performance parameters do not satisfy respective thresholds, run the iteration by reallocating at least the portion of the simulated containers to a second set of simulated hardware components of the second digital twin.

6. The system of claim 5, wherein:
the first portion of the computing infrastructure is located in a first geographical region; and
the second portion of the computing infrastructure is located in a second geographical region.

7. The system of claim 1, wherein the configuration parameters comprise one or more of, a particular time of a particular day, a particular day of a particular week, a particular day of a particular month, a particular geographical region related to the computing infrastructure, one or more particular servers of the computing infrastructure, one or more particular software components of the computing infrastructure, a particular central processing unit (CPU) load, a particular CPU-temperature, a particular amount of memory allocation, and an outage of one or more servers.

8. The system of claim 1, wherein the particular state of the computing infrastructure comprises one or more of a state of the computing infrastructure on a particular day, a state of the computing infrastructure at a particular time, a state of the computing infrastructure when one or more servers are out of service, and a portion of the computing infrastructure in a particular geographical region.

9. The system of claim 1, wherein the performance parameters include one or more of whether the job flow was successfully processed, a job latency of one or more jobs in the job flow, a central processing unit (CPU)-temperature of one or more CPUs in the computing infrastructure, a CPU load at one or more servers of the computing infrastructure, a memory allocation at one or more servers of the computing infrastructure.

10. A method for allocating computing resources to a job flow, comprising:
generating a plurality of simulated containers relating to the job flow, wherein each simulated container simulates a corresponding actual container relating to the job flow that is to run on a computing infrastructure, and wherein each container is a self-contained virtual environment that comprises software components to process at least a portion of a job relating to the job flow;
receiving configuration parameters relating to a digital twin of at least a portion of the computing infrastructure, wherein:
wherein the digital twin is a software representation of at least the portion of the computing infrastructure; and
the configuration parameters, when applied to the digital twin, configure the digital twin to mimic a particular state of the computing infrastructure;
configuring the digital twin based on the received configuration parameters;
running a simulation of the job flow on the digital twin that is configured based on the configuration parameters, wherein the simulation comprises deploying using a simulated load balancer of the digital twin, the simulated containers relating to the job flow on a plurality of simulated hardware components in a portion of the digital twin representing a corresponding portion of the computing infrastructure;
recording at least one performance parameter as a result of the simulation, wherein the at least one performance parameter is indicative of a performance of a simulated hardware component of the computing infrastructure; and
if one or more of the performance parameters do not satisfy respective thresholds, running an iteration comprising:
reallocating at least a portion of the simulated containers to a plurality of simulated hardware components of a different portion of the digital twin representing a corresponding different portion of the computing infrastructure;
rerunning the simulation after reallocating at least the portion of the simulated containers; and
if the one or more performance parameters satisfy the respective thresholds, recording an allocation of the simulated containers that resulted in the one or more performance parameters satisfying the respective thresholds.

11. The method of claim 10, further comprising assigning actual containers relating to the job flow to computing nodes in the computing infrastructure according to the recorded allocation of the simulated containers that resulted in the one or more performance parameters satisfying the respective thresholds, wherein the actual containers correspond to the simulated containers.

12. The method of claim 10, further comprising:
after rerunning the simulation, if the one or more performance parameters do not satisfy the respective thresholds, rerunning the iteration.

13. The method of claim 10, wherein:
the digital twin comprises a first digital twin and a second digital twin;
the first digital twin is a software representation of a first portion of the computing infrastructure;
the second digital twin is a software representation of a second portion of the computing infrastructure; and
further comprising:
running the simulation of the job flow on the digital twin by deploying the simulated containers on a first set of simulated hardware components of the first digital twin; and
if the one or more performance parameters do not satisfy respective thresholds, running the iteration by reallocating at least the portion of the simulated containers to a second set of simulated hardware components of the second digital twin.

14. The method of claim 13, wherein:
the first portion of the computing infrastructure is located in a first geographical region; and
the second portion of the computing infrastructure is located in a second geographical region.

15. The method of claim 10, wherein the configuration parameters comprise one or more of, a particular time of a particular day, a particular day of a particular week, a particular day of a particular month, a particular geographical region related to the computing infrastructure, one or more particular servers of the computing infrastructure, one or more particular software components of the computing infrastructure, a particular central processing unit (CPU) load, a particular CPU-temperature, a particular amount of memory allocation, and an outage of one or more servers.

16. The method of claim 10, wherein the particular state of the computing infrastructure comprises one or more of a state of the computing infrastructure on a particular day, a state of the computing infrastructure at a particular time, a state of the computing infrastructure when one or more servers are out of service, and a portion of the computing infrastructure in a particular geographical region.

17. The method of claim 10, wherein the performance parameters include one or more of whether the job flow was successfully processed, a job latency of one or more jobs in the job flow, a central processing unit (CPU)-temperature of one or more CPUs in the computing infrastructure, a CPU load at one or more servers of the computing infrastructure, a memory allocation at one or more servers of the computing infrastructure.

18. A computer-readable medium storing instructions that when executed by a processor causes the processor to:
generate a plurality of simulated containers relating to the job flow, wherein each simulated container simulates a corresponding actual container relating to the job flow that is to run on a computing infrastructure, and wherein each container is a self-contained virtual environment that comprises software components to process at least a portion of a job relating to the job flow;
receive configuration parameters relating to a digital twin of at least a portion of the computing infrastructure, wherein:
wherein the digital twin is a software representation of at least the portion of the computing infrastructure; and
the configuration parameters, when applied to the digital twin, configure the digital twin to mimic a particular state of the computing infrastructure;
configure the digital twin based on the received configuration parameters;
run a simulation of the job flow on the digital twin that is configured based on the configuration parameters, wherein the simulation comprises deploying using a simulated load balancer of the digital twin, the simulated containers relating to the job flow on a plurality of simulated hardware components in a portion of the digital twin representing a corresponding portion of the computing infrastructure;
record at least one performance parameter as a result of the simulation, wherein the at least one performance parameter is indicative of a performance of a simulated hardware component of the computing infrastructure; and
if one or more of the performance parameters do not satisfy respective thresholds, run an iteration comprising:
reallocate at least a portion of the simulated containers to a plurality of simulated hardware components of a different portion of the digital twin representing a corresponding different portion of the computing infrastructure;
rerun the simulation after reallocating at least the portion of the simulated containers; and
if the one or more performance parameters satisfy the respective thresholds, record an allocation of the simulated containers that resulted in the one or more performance parameters satisfying the respective thresholds.

19. The computer-readable medium of claim 18, wherein the instruction further cause the processor to assign actual containers relating to the job flow to computing nodes in the computing infrastructure according to the recorded allocation of the simulated containers that resulted in the one or more performance parameters satisfying the respective thresholds, wherein the actual containers correspond to the simulated containers.

20. The computer-readable medium of claim 18, wherein the instructions further cause the processor to:
after rerunning the simulation, if the one or more performance parameters do not satisfy the respective thresholds, rerun the iteration.
